(19) United States
(12) Patent Application Publication
(10) Pub. No.: US 2024/0228292 A1
(43) Pub. Date: Jul. 11, 2024

(54) SILICON PROMOTED SINGLE WALL CARBON NANOTUBE SYNTHESIS

(71) Applicant: University of Florida Research Foundation, Inc., Gainesville, FL (US)

(72) Inventors: Andrew Gabriel Rinzler, Gainesville, FL (US); Ramesh Jayaraman, Gainesville, FL (US)

(21) Appl. No.: 18/243,866

(22) Filed: Sep. 8, 2023

Related U.S. Application Data
(60) Provisional application No. 63/405,249, filed on Sep. 9, 2022.

(51) Int. Cl. C01B 32/162

(52) U.S. Cl. CPC C01B 32/162; C01B 2202/02; C01P 2002/82

(57) ABSTRACT

Various examples are provided related to synthesis of single wall carbon nanotubes (SWNTs). In one example, a method includes providing a vapor including a metal catalyst, silicon at a level of about 10 at % of the metal catalyst with balance carbon; synthesizing single wall carbon nanotubes (SWNTs) from the vapor; and collecting the synthesized SWNTs. The vapor including the metal catalyst, silicon and carbon can be provided in a variety of ways. Synthesis of the SWNTs can be an oxygen free synthesis.

### CROSS REFERENCE TO RELATED APPLICATIONS

This application claims priority to, and the benefit of, co-pending U.S. provisional application entitled “Silicon Promoted Single Wall Carbon Nanotube Synthesis” having Ser. No. 63/405,249, filed Sep. 9, 2022, which is hereby incorporated by reference in its entirety.

### BACKGROUND

The dual pulsed laser vaporization (DPLV) synthesis of single wall carbon nanotubes (SWNTs) developed in the mid-1990s was an important milestone in what was then the emerging science of carbon nanotubes. The high quality of the material produced, shared liberally with researchers worldwide, led to numerous important findings.

### SUMMARY

Aspects of the present disclosure are related to synthesis of single wall carbon nanotubes (SWNTs). In one aspect, among others, a method comprises providing a vapor comprising a metal catalyst, silicon at a level of about 10 at % of the metal catalyst with balance carbon; synthesizing single wall carbon nanotubes (SWNTs) from the vapor; and collecting the synthesized SWNTs. In one or more aspects of these embodiments, the vapor comprising the metal catalyst, silicon and carbon can be provided by initiating vaporization of a metal catalyst loaded graphitic target positioned within a heated tube furnace without a plume confinement tube, the metal catalyst loaded graphitic target comprising silicon oxide; and vaporizing at least a portion of the metal catalyst loaded graphitic target with pulsed lasers directed at the metal catalyst loaded graphitic target. The metal catalyst loaded graphitic target can comprise silicon oxide particles incorporated therein. The silicon oxide particles can be silicon (IV) oxide particles.

In various aspects, the metal catalyst loaded graphitic target can comprise nickel and cobalt catalysts. The pulsed lasers can generate Nd:YAG laser of 532 nm and 1064 nm wavelengths. The pulsed lasers can be synchronized with a defined arrival delay time. A gas flow can be maintained at a pressure of about 500 Torr. The gas flow can comprise Argon gas. The tube furnace can be heated to about 1200° C. The tube furnace can have an inner diameter of about 50 mm or greater. The inner diameter can be about 70 mm. The synthesized SWNTs can be collected on an inner surface of the tube furnace. In some aspects, a dual pulsed laser vaporization (DPLV) growth system can comprise the tube furnace. The vapor comprising the metal catalyst, silicon and carbon can be provided by initiating vaporization of a metal catalyst, silicon loaded graphitic anode rod in a helium background gas at between 500-700 Torr pressure by an electric arc maintained between the anode and cathode.

In one or more aspects, the vapor comprising the metal catalyst, silicon and carbon can be provided by injecting powders of carbon black, metal and silica compound into a plasma induction zone using a carrier gas. The silica compound can be a SiOx powder, a SiC powder, or vapor of an organo-silicon compound. The powders of carbon black, metal and silica compound can be vaporized in a plasma induction zone to provide feedstock for growth of the SWNTs. The vapor comprising the metal catalyst, silicon and carbon can be provided by vaporizing an organometallic and organosilica compounds. The organometallic compound can be a metallocene. The organosilica compound can be tetraethylorthosilicate. The organometallic and organosilica compounds can decompose in a high temperature furnace that pyrolyze in a stream of hydrocarbons to provide feedstock for growth of the SWNTs. Synthesis of the SWNTs can be an oxygen free synthesis.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate examples of S22 absorbance spectra and baseline subtraction for runs of non-Si loaded targets using a plume confinement tube, in accordance with various embodiments of the present disclosure.

FIGS. 2A and 2B illustrate examples of S22 absorbance spectra and baseline subtraction for runs of targets loaded with 0.18 at % Si without using a plume confinement tube, in accordance with various embodiments of the present disclosure.

FIGS. 3A and 3B illustrate an example of a dual pulsed laser vaporization (DPLV) growth system for synthesis of single wall carbon nanotubes (SWNTs), in accordance with various embodiments of the present disclosure.

### DETAILED DESCRIPTION

Disclosed herein are examples related to synthesis of single wall carbon nanotubes (SWNTs). The inclusion of a small amount of silicon along with the typical cobalt and nickel co-catalysts used to grow SWNTs in dual pulsed laser vaporization (DPLV) based synthesis of the material can dramatically enhance the yield of the SWNTs by increasing the percentage of nanotube to non-nanotube product that is generated. Reference will now be made in detail to the description of the embodiments as illustrated in the drawings, wherein like reference numbers indicate like parts throughout the several views.

Work with a DPLV system built for the synthesis of SWNTs suggests that an important factor in the early reports of high yields from the DPLV synthesis of SWNTs, originally attributed to plume confinement was rather due, at least in part, to an unrecognized source of silicon (Si) in those early synthesis experiments. As will be discussed, this is demonstrated by spectroscopic assay of DPLV synthesized product material with and without Si purposefully incorporated into the target. This result can find useful application in high volume methods of SWNT production such as, e.g., most directly in carbon arc and plasma torch-based syntheses.

The original optimized system that produced material estimated by SEM and TEM imaging to contain 90% SWNTs took place in a 22×25 mm diameter (ID×OD) quartz tube furnace in a 30 cm heated zone. A 12.5 mm diameter cylindrical, bi-metallic (Co/Ni, 0.6/0.6 at %) catalyst loaded graphitic target, coaxially supported within the quartz tube, was heated to 1200° C. Ultra-high purity argon gas, maintained at 500 Torr pressure, flowed downstream and passed the target at a controlled 100 sccm flow rate. Entering the furnace through a Brewster angle end flange and propagating along the direction of the Ar gas flow, two Q-switched Nd:YAG laser pulses (9 ns FWHM), of 532 nm and 1064 nm wavelengths, separated by 42 ns fired upon the target end-face at 10 Hz. The high temperature ablation plume vaporized from the target expanded up-stream against the gas flow direction where the high-density carbon and metal vapor condensed while thermalizing to the 1200° C. background gas temperature to nucleate and grow SWNTs.

Although the vaporization plume expanded upstream, the plume confinement provided by the 500 Torr Ar background, and its downstream gas flow entrained the growing SWNTs, forcing their turn around to again pass in proximity to the target. In the confined space of the small diameter tube furnace, the growing SWNTs were exposed to additional feedstock from subsequent laser vaporization plumes as well as being exposed to the passing laser beams, allowing for re-vaporization of condensed amorphous carbon and metal particles. Although the laser beam diameters (focused down to about 3 mm at the target face) occupied only a small fraction of the quartz tube's cross-section, the violence of the ablation ensured turbulent mixing, exposing much of the entrained material to the beams.

The problem with this system was that the tangled, web-like deposits of SWNTs would soon clog the limited space between the target and the quartz tube wall, resulting in the growth run being terminated. One such run generated about 10-20 mg of the high quality SWNT material before having to stop, cool back to room temperature, collect the material, and set-up to run again. This limited the production rate to about 80 mg per {labor-intensive) day. Given the high demand for the material, and the production limit set by the small diameter tube furnace, one solution was the use of a larger diameter quartz tube furnace.

However, along with the switch to a larger diameter (50 mm) tube furnace, the percentage of SWNT in the collected material immediately dropped to a quantity estimated to have been less than 50%. Ultimately the confinement in the small diameter system described above was recognized as being important to generating the highest percentage SWNTs. A compromise solution, yielding material estimated to be 70% SWNTs, was a larger diameter tube furnace within which was contained a small diameter tube ending near the target face, in which the upstream flowing plume was confined. This was less effective than the most constrained geometry discussed above but allowed the uninterrupted production of about 1-2 g/day.

This explanation for the effect of confinement in generating the highest percentage SWNTs is consistent with all observations and has stood for 20 years. However, work with a DPLV SWNT production system that replicates the small diameter plume confinement tube within a larger diameter tube furnace, led to another possibility. The testing strongly implicates another major factor in generating the highest percentage SWNTs: the availability of a small quantity of silicon in the condensing vaporization plume.

The first indication that Si was present during the growth came from proton induced x-ray emission (PIXE) based elemental analysis of the produced SWNT material. This showed Si to be present at level of approximately 0.1%. PIXE analysis of the target from which the SWNTs were produced, however, showed Si to be below the 13 ppm detection limit. Energy dispersive spectroscopy in an SEM similarly showed the presence of Si in the raw SWNT material, while none was detected in the target. The only available source of Si was from the quartz of the confinement tube and the tube furnace.

On initial consideration this would seems unlikely. The inertness of quartz, even at 1200° C., makes it the material of choice for tube furnaces, indeed the 1200° C. limit comes about because quartz begins to soften and deform at this temperature. Under oxygen starved conditions, at 1200° C., the equilibrium partial pressure of SiO gas, over SiO₂ solid is calculated from thermodynamic parameters to be less that 10⁻⁷ Bar (the partial pressure of SiO₂ gas being far smaller still). However, under SWNT growth conditions, carbon and the metal catalysts are also present. Following a SWNT growth run the confinement tube in the region nearest the target becomes coated with a dense black deposit. If this tube is then heated in ambient air at 900° C., the carbon is driven off as CO₂, but rather than recover the tube's original glass-like sheen, it is found to possess a deeply frosted appearance, as if it had been etched. Silicon carbide only begins to form at higher temperatures. It is therefore inferred that the deposited metals and/or carbon catalyze the decomposition of SiO₂ to SiO which possesses a far more appreciable equilibrium partial pressure over solid SiO, measured at 1200° ° C. to be about 1.1×10⁻⁴ Bar.

The finding of Si in the SWNT product, and this suggestion for how it finds its way into the material, does not address the conclusion that it could affect the percentage of SWNTs generated. In CVD synthesis, when catalytic metal particles are placed directly on bare Si substrates SWNT growth is suppressed. But this is generally understood to occur because the transition metal catalysts are carbide/silicide formers that diffuse into the substrate (with an oxide layer typically used to avoid such suppression). On the other hand, SWNTs have been grown entirely metal-catalyst-free by alcohol or CH₄ CVD on pure defective SiO₂ with the defects coming either from the sputtering process used to deposit the oxide or by scratching a high quality thermal SiO₂ layer with a diamond scribe.

Perhaps more relevant were studies that found a dramatic enhancement of the SWNT yield in inverse diffusion flame synthesis using an Fe/Si/O catalyst. But there the Si comprised half the catalytic metal content (a much greater percentage of Si relative to the metals than found in this product) and the mechanism was ascribed to phase segregation and partial SiO₂ cap formation on the Fe metal particles that encouraged hemi-Fullerene caps as precursors to SWNT growth on the opposing side of the particles.

Much less Si was found in the product in DPLV synthesis, and without the excess oxygen necessary in flame synthesis (which, unfortunately, also damages the resulting SWNTs) there would be no oxygen available in the inert Ar atmosphere of DPLV to form the proposed SiO₂ cap. Nevertheless, these studies, combined with lingering doubts about the completeness of the existing explanation for what gave the highest percentage SWNTs in DPLV fueled further examination of an enhancing effect. Note that the concentration of SiO in the condensing plume material, in the region most relevant to the nucleation of the SWNTs would also depend on the proximity of the quartz tube from which that SiO came. All of which resulted in further probing.

Regardless of the rationale, the test for the effect of Si was straight forward. Silicon (IV) oxide particles (80 nm, Alfa Aesar) were directly incorporated into metal catalyst loaded graphitic targets such that they were vaporized along with the carbon and metal catalysts. Growth runs with these targets were undertaken without a plume confinement tube (in a large bore, 70 mm ID, quartz tube furnace) and assays of the relative fraction of SWNTs produced were then compared with the relative fraction of SWNTs produced from otherwise identical non-Si loaded targets grown in the same system, under the same conditions, but using a plume confinement tube in front of the target.

Although the source of Si we used was an oxide, it would understood by one of skill in the art that in the high energy, high carbon vapor environment of the ablation plume, this would quickly be reduced to pure Si or SiC and without another form of added oxygen the small amount of oxygen (relative to the carbon) that came from the SiOx would be taken off as CO (or CO₂) and not be available to reoxidize the Si.

Assay of the SWNT product by SEM and TEM, as originally performed on material from the optimized system, was undoubtedly subjective. Fortunately, a much more reliable method of SWNT material assay had since been developed. This relies on NIR optical spectroscopy across the S22 absorption band of the as produced material dispersed by ultrasonication in N,N dimethylformamide (DMF). DMF possesses high transparency in the relevant spectral region and allows for unstable, but useful dispersion of the material under ultrasonication. The SWNT S22 absorption band rides on a broad, underlying π-plasmon absorption. This is due in part to the SWNTs, but importantly also due to the other forms of carbon in the sample.

To generate a Haddon purity index, one measures the integrated intensity across the SWNT S22 absorbance band after a linear subtraction of the underlying π-plasmon absorption. This spectral area is due strictly to the SWNTs in the sample. If this is now divided by the total integrated intensity under the curve, including the underlying π-plasmon contribution, one has a reasonable relative measure of the fraction of SWNTs in the sample. Among the benefits of the method is that around the 5-10 μg/ml of the SWNT material concentration used, it is largely independent of the material concentration. If the SWNTs did not have their own contribution to the underlying π-plasmon, an analytically pure sample of 100% SWNTs would yield a Haddon purity index of 1. Because, however, the SWNTs themselves contribute significantly to the underlying π-plasmon, the index of even the purest SWNT sample is substantially lower. It has been estimated that an analytically pure SWNT sample would have an index of about 0.325.

In the original studies during which the Haddon purity index was developed, to obtain a sample in which the amorphous and other carbons were minimized, a coarse stainless steel wire mesh grid was placed around the region of the carbon arc in the arc apparatus onto which SWNTs were trapped. In this region, more directly exposed to the violent vapor out flows of the arc, extended particles having appreciable cross-section, without the benefit of the long, adhering, contact lengths of the nanotubes, were blown through, while some SWNT bundles were trapped (higher local heating in the vicinity of the grid also likely served to evaporate fullerenes from the trapped SWNTs). This material, which by SEM imaging appeared exceptionally pure, gave a Haddon index of 0.141. When this material was homogenized with the rest of the material collected in that growth run, the Haddon index evaluated to an average value of 0.0490±0.0025. With this baseline for such assays, consider the SWNT material produced in the laboratory.

The material synthesized in the system collects along the top half of the 70 mm ID quartz tube at the exit of the furnace. Over a 4-hour run, the material formed a thick felt-like deposit. This material readily separated cleanly from the inner wall of the quartz tube and held together well. Material collected from the same region of this extended SWNT felt yielded very similar Haddon purity indices. After a 4-hour run, this felt was thick enough that it was possible to sample material from both the side that had deposited adjacent to the quartz tube, consisting of material synthesized early in the run, as well as material from the felt's opposite side, consisting of material produced late in the run.

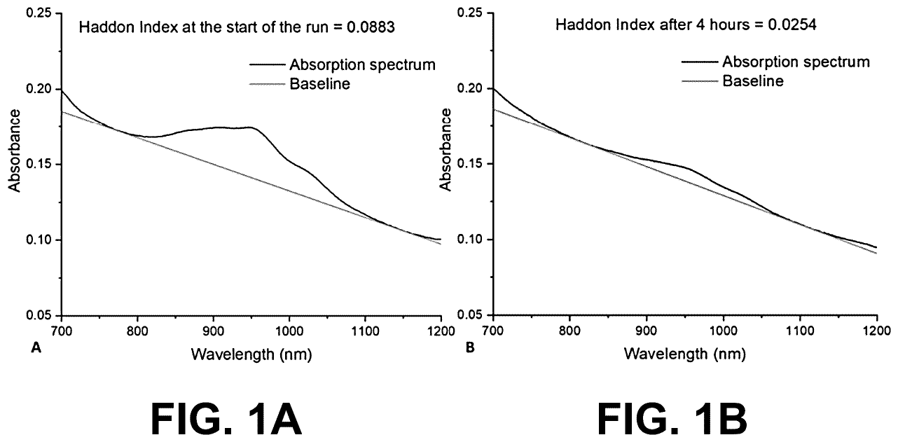

For runs of the non-Si loaded targets that used a plume confinement tube, what was generally found in such assays is shown in FIGS. 1A and 1B, which illustrate examples of S22 absorbance spectra and baseline subtraction used to establish the Haddon purity index of SWNT material deposited at different times over a 4-hour run using the typical (Ni/Co, non-Si loaded) graphitic target. The material synthesized and deposited early in the run had the S22 band shown in FIG. 1A yielding a Haddon index of 0.0883, while the material produced and deposited late in the run had the S22 band shown in FIG. 1B resulting in a Haddon index of only 0.0254, a factor of nearly 3.5 lower. Such material purity degradation over the course of long runs was consistently observed.

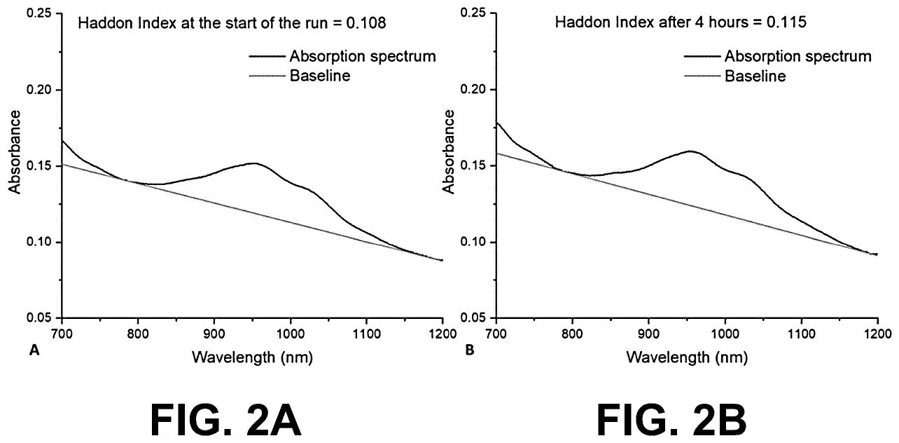

In contrast to this, FIGS. 2A and 2B show the result of the same experiment performed with a target, otherwise similar to the previous target, except now loaded with 0.18 at % Si and run in the same system under the same conditions, but without the use of a plume confinement tube. FIGS. 2A and 2B illustrate examples of S22 absorbance spectra and baseline subtraction used to establish the Haddon purity index of the SWNT material deposited at different times over a 4-hour run, without the benefit of a plume confinement tube and using a target otherwise similar to that used to generate FIGS. 1A and 1B, but additionally containing 0.18 at % Si. FIG. 2A illustrates the material deposited early in the run, and FIG. 2B illustrates the material deposited late in the run. At the start of the run the Haddon purity index obtained was 0.108 and at the end of the run the Haddon purity index was found to be 0.115!

Apart from the higher purity index of the Si loaded target, run without a plume confinement tube, there was an unusual lack of degradation over the course of the run. Degradation of the SWNT purity over the course of production runs with non-Si loaded targets had been seen previously in SEM and TEM analysis, with differing explanations. In one explanation the degradation occurred due to the development of millimeter scale conical spikes across the initially flat target surface over the course of its ablation. The SWNT purity was thought to degrade due to the local decrease in the laser intensity as its energy was distributed across the increasing target surface area with increased surface roughening (the intensity impinging on the surface depending on the cosine of the angle between the local surface normal and the radiation Poynting vector). In another explanation the purity reduction was ascribed to an apparent accumulation of the catalytic metals at the target surface (observed in its post growth imaging) resulting in a suboptimal, higher catalyst concentration. Although, this appears to have ignored the fact that previously vaporized catalyst can redeposit on the target surface, once laser ablation ceases.

In the present case, at the end of its 4-hour run the Si loaded target exhibited the same conical spikes as the non-Si loaded targets and there is no reason to believe that any surface catalyst concentration, to the extent it occurred on one, would not occur on the other. Since even one counterexample is sufficient to invalidate a hypothesis, the lack of degradation observed in the purity index of the Si loaded target serves to invalidate both previously proposed explanations for the degradation seen with non-Si targets. What causes such degradation needs an alternative explanation, perhaps having to do with the Si supply from the plume confinement tube as it becomes increasingly coated with the metal catalyst and carbon deposits.

Targets were also fabricated with Si concentrations of 0.09 at %, 0.45 at %, and 0.90 at %. SWNT yield enhancement was observed with the 0.09 at % Si concentration. This was further improved with the 0.18 at % Si concentration target, but the yield fell off with the higher 0.45 at % and 0.90 at %

The mechanism by which the SiO₂ incorporated into the targets acts to enhance the SWNT purity is not readily apparent. However, the following conjectures can be made. As a dielectric, the SiO₂ particles incorporated in the target do not likely absorb much of the laser energy, however, the extreme temperature and violent bombardment by the surrounding carbon, that does absorb the laser energy, can be expected to dissociate the SiO₂ particles to their constituent elements. The much greater availability of carbon in the vaporization plume would result in the consumption of the oxygen as CO, leaving the Si to bond with the condensing carbon. Si doped fullerenes, where the Si is incorporated into the fullerene cage structure, can be produced in the pulsed laser vaporization of Si/carbon targets.

It is also known that the SWNT yield in laser vaporization correlates with the conditions under which C₆₀ production is maximized in a pure graphitic target. The latter implies that C₆₀ and other small fullerenes constitute a prime feedstock for SWNT growth. But this requires that those fullerenes be disassembled by the metal catalyst particles at the ends of growing nanotubes for their carbon to become part of a growing tube wall. A growing SWNT provides an increasing surface area for the van der Waals capture of free-floating fullerenes and their ferry, by diffusion, along the tube wall to the metal catalyst particle at its growing end. While this scenario is admittedly speculative, it is proposed as a likely mechanism whereby the Si, incorporated as Si doped fullerenes is delivered to the metal catalyst particles, where they facilitate some aspect of the catalytic growth.

While the experimental findings are for DPLV synthesized SWNTs, the enhancement by Si can also be applied to other methods of high temperature SWNT production. High temperature (>1100° C.) inert atmosphere methods of SWNT production produce the highest quality SWNTs possessing long mean lengths with minimum side wall defects (missing carbon atom or pentagon-heptagon pairs) per unit length. In these methods the inert atmosphere avoids carbon loss by oxidation, while the high temperature facilitates the annealing out of any stochastically incorporated side wall defects. Since, as shown in this work, a small quantity of Si made available in the nucleation zone during the synthesis enhances the SWNT yield in DPLV, it can be readily inferred that a small quantity of Si made available to the growing SWNTs in other methods of SWNT production will similarly enhance the production yield.

For example, in Carbon Arc SWNT production an electric arc is struck between a cathode and a graphitic anode rod that contains a mixture of catalytic metals (often 1 at % of yttrium, 4 at % of nickel, balance carbon) in an inert background of He gas at 500-700 Torr pressure. In some cases the metals are mixed with graphite powder and compacted into a hole drilled into the center of a pure graphitic rod which is then used as the anode rod while in other cases the anode rod is formed as a green body consisting of graphite powder mixed with the metal catalysts and a binder, which must be pyrolyzed, similar to the targets used in DPLV. In either case the anode rod with its mixture of catalytic metals is vaporized by the electron bombardment from the plasma formed in the arc providing the feedstock that forms the SWNTs. Independent of the method used to form the anode rod SiOx particles can be incorporated into the graphitic anode rod either by mixing SiOx particles with the metal and graphitic powders followed by their compaction into the graphitic anode rod or by their incorporation into the green body as was done for the DPLV targets. Insofar as all methods of SWNT growth are sensitive to the specific growth parameters the quantity of SiOx to incorporate will have to be determined experimentally for the growth conditions used but are likely to be about 10% of the total catalytic metal content.

As noted in the discussion of what happens to the SiOx in DPLV, the SiOx is likely decomposed to atomic Si but even if some SiO survives the energy of the ablation pulse, this SiO would be reduced to atomic Si or a Si—C complex in the strongly reducing carbon vapor ambient that follows the laser ablation pulses. With so little oxygen and so much carbon available to take the oxygen off as carbon monoxide the likelihood of oxygen playing a role in the synthesis is negligible (CO can decompose to C on a metal catalyst as in the Boudouard reaction used in HiPCO SWNT synthesis, but this is a bimolecular reaction requiring the simultaneous interaction of two CO molecules on a metal catalyst that requires a very high concentration of CO, hence the high pressure CO ambient used in the HiPCO process). The point is that it is the Si that plays the critical role in enhancement of the SWNT yield. This makes it relevant to consider alternative methods of introducing the Si to the feedstock for the synthesis. One alternative means would be to simply replace the SiOx particles with SiC particles as could readily be done in the DPLV target or Carbon Arc anode rod.

In other methods of SWNT synthesis still other forms of introducing a small quantity of Si may be used. In the Induction Thermal Plasma Torch synthesis method carbon black and metals are injected as fine powders by a carrier gas stream into the plasma induction zone to rapidly vaporize the raw materials providing the feedstock from which the SWNTs are synthesized. Here again SiOx or SiC powders can be added in quantities of about 10% of the total metal catalyst content (about 10 at %) to enhance the SWNT yield.

Deviating further from these is the Enhanced Direct Injection Pyrolytic Synthesis (eDIPs) Method in which the catalyst is one or more organometallic compound(s) (metallocenes) that are vaporized and injected into a high temperature furnace where they decompose to the catalytic metal in a flowing stream of hydrocarbons that react on that metal catalyst to provide the carbon feedstock for growth of the single and few walled carbon nanotubes. In such a case there exist organosilica compounds such as for example tetraethylorthosilicate that can be co-vaporized for injection into the high temperature furnace to provide the Si source to enhance the SWNT yield there.

### EXAMPLES

Targets were fabricated by thoroughly mixing micron scale graphitic (Alfa Aesar graphite APS 2-15 microns 99.9995% purity), nickel ((Alfa Aesar APS 2.2-3.0 microns, 99.9% purity) and cobalt (Alfa Aesar 1.6 microns, 99.8% purity) powders with a poly(furfuryl) alcohol (PFA) binder. For Si loaded targets silicon (IV) oxide particles (80 nm, Alfa Aesar) were also added to the powder mixture. The quantity of the metal, Si, and graphite powders, as well as the PFA used, were based on computations devised to yield completed targets comprised of 1 at % each of Co and Ni, the at % of Si discussed above, with the balance carbon, under the assumption that half the PFA mass used was pyrolyzed during the bake cycle to carbon (the other half coming off as liquid and gaseous organic products These materials were thoroughly mixed and compressed at high pressure in a 45.7 mm diameter cylindrical mold at 210° C. to polymerize the binder and produce a nominally 25 mm thick cylindrical green body. This green body was subsequently slowly pyrolyzed under a low flow of 99.999% Ar in a 70 mm diameter quartz tube furnace over a 35-hour schedule tailored to avoid cracks in the final target. The completed targets possessed a bulk density measuring 1.7-1.8 g/cm³.

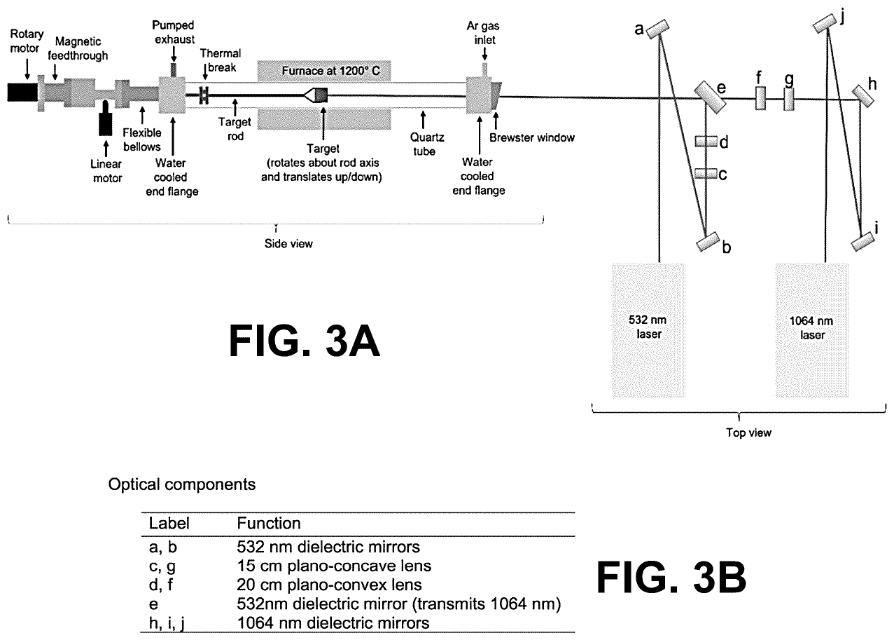

FIG. 3A is a schematic illustrating an example of the DPLV growth system. The laser table and optical components (functions listed in the table of FIG. 3B) are a top view. The tube furnace and associated components are a side view. The inner plume confinement tube and baffles discussed herein are omitted for clarity. The target is supported at the end of a 12.5 mm diameter, high-temperature tolerant Haynes 214 alloy rod in a 70×75 mm (ID×OD) diameter quartz tube furnace well within its 61 cm long heated zone, set to 1200° C. The target location within the furnace is offset to place its unobstructed side (opposite the alloy support rod) 15 cm from the furnace center, facing the hottest central zone of the furnace. The lasers fire onto the target face through a Brewster angle window in a water-cooled end flange sealed via a Viton a-ring to the 75 mm OD furnace quartz tube. The laser pulses propagate to the target face through a long 22×25 mm tube extending from the Brewster window end flange to within 75 mm of the target face (tube not shown in FIG. 3A). A 26×29 mm, 210 mm long quartz, plume confinement tube, is slid over the end of the long 22×25 mm tube, providing support for the shorter tube. This short plume confinement tube makes up the remaining distance to within 10 mm of the target end face (also not shown in FIG. 3A).

On the side of the furnace opposite the Brewster window the 70×75 mm quartz furnace tube is supported by a second Viton a-ring sealed, water-cooled end flange. This side incorporates a mechanism driven by two computer-controlled motors that rotate the target support rod about its axis while separately adjusting the rod's angle with respect to the horizontal. These allow for rotation and translation of the target within the furnace hot zone such that the stationary laser beams can access the entire target endface. A magnetically coupled rotation stage and flexible vacuum bellows allow for these motions without compromising the system's atmospheric isolation.

During SWNT growth, the 99.999% Ar gas background is automatically maintained at 500 Torr with 100 SCCM of 99.999% Ar flowing in via a gas feedthrough on the Brewster window side into the 22×25 mm quartz tube. Machined graphitic baffles within the 70×75 mm quartz tube at the furnace entrance and exit (not shown in FIG. 3A) are used to reduce the gas convection cells that would otherwise draw cold gasses into the heated zone.

The two Spectra Physics Quanta-Ray Pro 250-30 Nd:YAG lasers fire on the target at 30 Hz along the optical paths shown in FIG. 3A. The first laser is harmonically doubled to 532 nm and its beam is reflected by a dielectric mirror coated to reflect 532 nm but transmit 1064 nm radiation. The 532 nm pulse reflected from this mirror passes through the Brewster window end flange, along the central axis of the 22×25 mm quartz tube to the end-face of the target delivering 413 mJ/pulse focused to a 5.6 mm diameter spot. The beam of the 2nd laser, firing at 1064 nm transmits through the 532 nm reflecting mirror placing it on the same optic axis as the 532 nm beam to the target. The IR laser delivers 800 mJ/pulse focused to a 5.8 mm diameter spot which is delayed to arrive 39 ns after the green pulse.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method, comprising:
providing a vapor comprising a metal catalyst, silicon at a level of about 10 at % of the metal catalyst with balance carbon;
synthesizing single wall carbon nanotubes (SWNTs) from the vapor; and
collecting the synthesized SWNTs.

2. The method of claim 1, wherein the vapor comprising the metal catalyst, silicon and carbon is provided by:
initiating vaporization of a metal catalyst loaded graphitic target positioned within a heated tube furnace without a plume confinement tube, the metal catalyst loaded graphitic target comprising silicon oxide; and
vaporizing at least a portion of the metal catalyst loaded graphitic target with pulsed lasers directed at the metal catalyst loaded graphitic target.

3. The method of claim 2, wherein the metal catalyst loaded graphitic target comprises silicon oxide particles incorporated therein.

4. The method of claim 3, wherein the silicon oxide particles are silicon (IV) oxide particles.

5. The method of claim 2, wherein the metal catalyst loaded graphitic target comprises nickel and cobalt catalysts.

6. The method of claim 2, wherein the pulsed lasers generate Nd:YAG laser of 532 nm and 1064 nm wavelengths.

7. The method of claim 2, wherein the pulsed lasers are synchronized with a defined arrival delay time.

8. The method of claim 2, wherein a gas flow is maintained at a pressure of about 500 Torr.

9. The method of claim 8, wherein the gas flow comprises Argon gas.

10. The method of claim 2, wherein the tube furnace is heated to about 1200° C.

11. The method of claim 2, wherein the tube furnace has an inner diameter of about 50 mm or greater.

12. The method of claim 11, wherein the inner diameter is about 70 mm.

13. The method of claim 2, wherein the synthesized SWNTs are collected on an inner surface of the tube furnace.

14. The method of claim 2, wherein a dual pulsed laser vaporization (DPLV) growth system comprises the tube furnace.

15. The method of claim 1, wherein the vapor comprising the metal catalyst, silicon and carbon is provided by:
initiating vaporization of a metal catalyst, silicon loaded graphitic anode rod in a helium background gas at between 500-700 Torr pressure by an electric arc maintained between the anode and cathode.

16. The method of claim 1, wherein the vapor comprising the metal catalyst, silicon and carbon is provided by injecting powders of carbon black, metal and silica compound into a plasma induction zone using a carrier gas.

17. The method of claim 16, wherein the silica compound is a SiOx powder, a SiC powder, or vapor of an organo-silicon compound.

18. The method of claim 16, wherein the powders of carbon black, metal and silica compound are vaporized in a plasma induction zone to provide feedstock for growth of the SWNTs.

19. The method of claim 1, wherein the vapor comprising the metal catalyst, silicon and carbon is provided by vaporizing an organometallic and organosilica compounds.

20. The method of claim 19, wherein the organometallic compound is a metallocene.

21. The method of claim 19, wherein the organosilica compound is tetraethylorthosilicate.

22. The method of claim 19, wherein the organometallic and organosilica compounds decompose in a high temperature furnace that pyrolyze in a stream of hydrocarbons to provide feedstock for growth of the SWNTs.

23. The method of claim 1, wherein synthesis of the SWNTs is an oxygen free synthesis.
